(19) United States
(12) Patent Application Publication
(10) Pub. No.: US 2012/0212866 A1
(43) Pub. Date: Aug. 23, 2012

(54) OUTPUT DRIVER

(75) Inventors: Chen-Ting KO, Hsinchu City (TW); Jinn-Yeh CHIEN, Chu Bei City (TW)

(73) Assignee: TAIWAN SEMICONDUCTOR MANUFACTURING COMPANY, LTD., Hsinchu (TW)

(21) Appl. No.: 13/029,706

(22) Filed: Feb. 17, 2011

(51) Int. Cl. H02H 9/04

(52) U.S. Cl. 361/56

(57) ABSTRACT

An output driver having a power supply line, a control switch, at least one protection device and at least one voltage clamp device. The control switch disposed between the at least one protection device and the power supply line an output line. The at least one protection device disposed in a series arrangement between the output line and the control switch. The at least one voltage clamp device disposed across a corresponding protection device and adapted to clamp a voltage across the protection device below a predetermined threshold voltage.

### BACKGROUND

As semiconductor circuits are made smaller, the operating voltage of the transistors is scaled in order to prevent breakdown of the transistors. As a result, the output voltage of gates and drivers is also reduced. Some legacy systems; however, require a higher output voltage from the gates than the transistors forming the gates can withstand. Therefore, circuits having additional transistors in a cascode arrangement are used to switch higher output voltages.

### DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a schematic diagram of an output driver according to an embodiment;

FIG. 2 is a graph of voltage versus time for various voltages of the driver of FIG. 1 without a voltage clamp;

FIG. 3 is a graph of voltage versus time for various voltages of the driver of FIG. 1;

FIG. 4 is a schematic diagram of an output driver according to an embodiment;

FIG. 5 is a schematic diagram of an output driver according to another embodiment;

FIG. 6 is a schematic diagram of an output driver according to another embodiment; and

FIG. 7 is a flow chart for a method of operating the output driver of FIG. 1.

### DETAILED DESCRIPTION

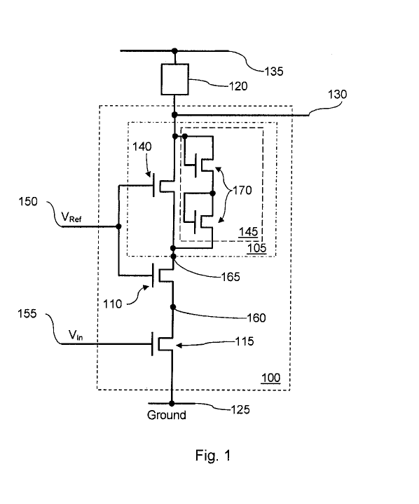

FIG. 1 is a schematic diagram of an output driver 100 according to an embodiment. Output driver 100 comprises a voltage clamped protection device 105, an intermediate protection device 110 and a control switch 115 serially arranged and sequentially connected from a load 120 to a ground power line 125. The output driver 100 further comprises an output line 130 connected to the connection between the load 120 and the voltage clamped protection device 105. The load 120 is disposed between output driver 100, via voltage clamped protection device 105, and a positive power line 135.

The voltage clamped protection device 105 comprises a protection device 140 and a voltage clamp 145 disposed across, i.e., connected to a source and drain of the protection device. A drain of the protection device 140 is connected to the output line 130 and a source of the protection device is connected to a drain of the intermediate protection device 110. A gate of the protection device 140 is connected to a voltage reference line 150.

A gate of the intermediate protection device 110 is connected to the voltage reference line 150 and a source of the intermediate protection device is connected to a drain of the control switch 115.

The control switch 115 is disposed between the intermediate protection device 110 and the ground power line 125. A source of the control switch 115 is connected to the ground power line 125 and a gate of the control switch is connected to an input line 155.

A first node 160 is the connection between the drain of the control switch 115 and the source of the intermediate protection device 110. A second node 165 is the connection between the drain of the intermediate protection device 110 and the source of the protection device 140.

The voltage clamp 145 comprises two diode-connected n-channel metal oxide semiconductor (MOS) transistors 170. Each of the diode-connected n-channel MOS transistors 170 has a threshold voltage of, for example, about 0.65V.

The control switch 115, the intermediate protection device 110 and the protection device 140 are n-channel MOS devices.

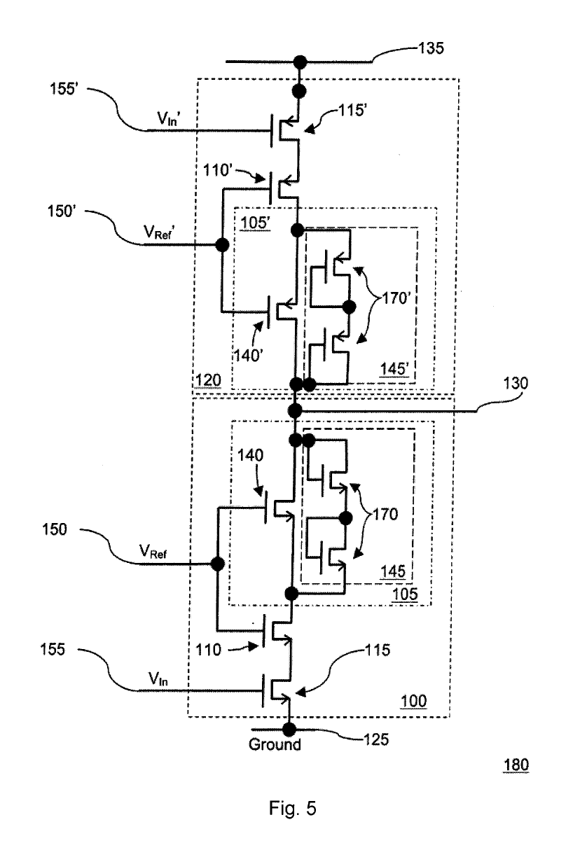

In some embodiments, the load 120 for output driver 100 is a resistor. In other embodiments, the load is another similar complementary output driver to output driver 100, but formed from p-type devices. FIG. 5 is an embodiment of an output driver 180 in which the load 120 is a complementary-symmetric version of output driver 100. Each element in load 120 with a “′” being the complementary element to the element without a “′” in the output driver 100. Each transistor in load 120 being a p-channel (MOS) transistor. The complementary output driver 180 has a complementary input line 155′ and complementary voltage reference line 150′.

In operation, the currents and voltages applied to the output driver 100 are configured to prevent damage to the control switch 115, the intermediate protection device 110 and the protection device 140. In particular, a voltage larger than a voltage that causes hot carrier injection is not applied across the control switch 115, the intermediate protection device 110 and the protection device 140 when current is flowing through the foregoing devices. If the voltage across a MOS device is too great while current is flowing through the MOS device, the MOS device is damaged due to hot carrier injection. In hot carrier injection, electrons forming the current flow through a channel of the MOS device gain sufficient energy to be injected into a gate oxide of the MOS device, thereby changing a threshold of or destroying the device.

In operation, an input voltage on the input line 155 controls current flow through the control switch 115, and thus the current flow between the output line 130 and the ground power line 125. If the input line 155 is at the voltage of the ground power line 125 (0V), the current flow through the control switch 115 is zero. The current flow through the intermediate protection device 110 and the protection device 140 is thus also zero. Because the current flow through the output driver 100 is zero the output line 130 is held at a high logic output state corresponding to a voltage of the positive power line 135 by the load 120. The protection device 140 and the intermediate protection device 110 protect the control switch 115 from voltage values that cause hot carrier injection.

The protection device 140 and the intermediate protection device 110 have a threshold voltage. The threshold voltage is, for example, about 0.65V. Given that a voltage value on the voltage reference line 150 is set at V_{Ref}, if the voltage at the first node 160 between the control switch 115 and the intermediate protection device 110 rises above V_{Ref} minus the threshold voltage of the intermediate protection device, the intermediate protection device switches off preventing the voltage at the first node 160 from rising above V_{Ref} minus the threshold voltage. If the voltage at the second node 165 rises above V_{Ref} minus the threshold voltage of the protection device, the protection device switches off preventing the voltage at the second node 165 from rising above V_{Ref} minus the threshold voltage. Thus, a voltage higher than V_{Ref} minus the threshold voltage is not applied across the control switch 115, if the input line 155 is at the voltage of the ground power line 125.

The protection device 140, the intermediate protection device 110 and the control switch 115 form a cascode arrangement.

If the input line 155 is at a voltage corresponding to a high logic value, for example 1.65 V, the control switch 115 switches on and current flows through the control switch, the intermediate protection device 110 and the protection device 140. Thus, output line 130 is switched to a low voltage corresponding to a low logic valve. The voltages on the first and second nodes 160, 165 and output line 130 are at a voltage corresponding to a low logic value, i.e., a low logic output state which is substantially the voltage on the ground line 125. Therefore, the voltages across the control switch 115, the intermediate protection device 130 and the protection device 140 are all substantially zero and none of the devices is damaged in this state.

Thus, a high voltage is not applied across the control switch 115, the intermediate protection device 110 and the protection device 140 when current flows through the foregoing devices and the output driver 100 is protected from hot carrier injection in both the high logic output state and the low logic output state.

As the output line 130 switches from the high logic output state to the low logic state responsive to the input line 155 switching from the low logic output state to the high logic state. The control switch 115 switches from a non-conducting state to a conducting state responsive to the voltage on the input line 155. As the control switch 115 switches, the current that flows through the control switch discharges the voltage on the first node 160 toward the voltage on the voltage of the ground power line 125. Because the voltage between the voltage reference line 150 and the first node 160 is above the threshold voltage of intermediate protection device 110, the intermediate protection device switches on. Current flows through the intermediate protection device 110 and discharges the voltage on the second node 165. Because the voltage between the voltage reference line 150 and the second node 165 is above the threshold voltage of protection device 140, the protection device switches on.

The output line 130 has a high capacitance compared with the first and second nodes 160, 165 and does not discharge as rapidly as the first and second nodes 160, 165. The output line 130 discharges from the high logic output state corresponding to the voltage of positive power line 135 through the protection device 140. If the voltage clamp 145 is not present then the voltage across the protection device 140 becomes larger than the voltage that causes hot carrier injection into the gate of the protection device 140.

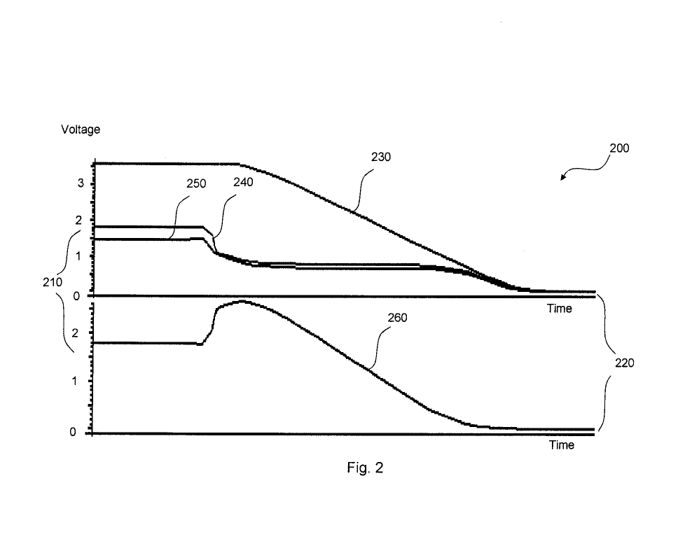

FIG. 2 is a graph 200 of voltage versus time for the output line 130, the first and second nodes 160, 165 and the voltage across the protection device 140 as the output driver switches from a high logic output state to a low logic output state if the voltage clamp 145 is absent. In this example, the voltage on the positive power line 135 is 3.6V, the voltage V_{Ref} is 1.65V and the threshold voltage of the intermediate protection device 110 and the protection device 140 is 0.65V.

The y-axis 210 represents voltage and the x-axis 220 represents the passage of time. The line 230 represents the voltage on the output line 130, the line 240 represents the voltage on the second node 165, the line 250 represents the voltage on the first node 160. As discussed above, the voltages on the first and second nodes 160, 165 discharge as the control switch 115 switches on. The voltage on the control line 150 discharges more slowly than the voltages on the first and second nodes 160, 165 due to the larger capacitance of the control line compared with the first and second nodes. The line 260 represents the voltage across the protection device 140. The voltage across the protection device 140 peaks at 2.65V due to the difference in capacitance between the first and second nodes 160, 165 and the output line 130.

Thus, without the voltage clamp 145 the voltage across the protection device 140 and current flow through the protection device are high enough for a period of time as the output driver switches to cause hot carrier injection into a gate oxide of the protection device 140 and damage to that device.

As the output line 130 is switched from the high logic output state and the low logic output state, with the voltage clamp 145 present. The two diode-connected n-channel MOS transistors 170 that form the voltage clamp 145 conduct if the voltage across both of diode-connected n-channel MOS transistors 170 is greater than the sum of threshold voltages of the devices. Therefore, if the threshold voltage of diode-connected n-channel MOS transistors 170 is, for example, 0.65V, then the diode-connected n-channel MOS transistors 170 begin to conduct if the voltage across the two diode-connected n-channel MOS transistors 170 exceeds 1.3V

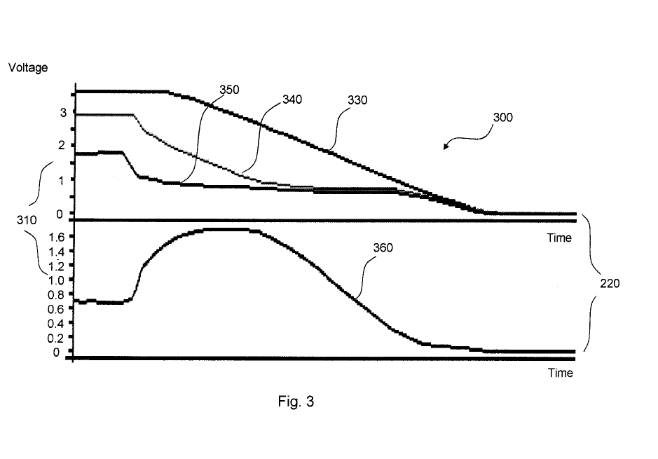

FIG. 3 is a graph 300 of voltage versus time for the output line 130, the first and second nodes 160, 165 and the voltage across the protection device 140 as the output driver switches from a high logic output state to a low logic output state with the voltage clamp 145 present. In this example, the voltage on the positive power line 135 is 3.6V, the voltage V_{Ref} is 1.65V and the threshold voltage of the intermediate protection device 110 and the protection device 140 is 0.65V.

The y-axis 310 represents the voltage and the x-axis 320 represents the passage of time. The line 330 is the voltage on the output line 130, the line 340 is the voltage on the second node 165, and the line 350 is the voltage on the first node 160. The voltage on the first node 160 discharges as the control switch 115 switches on. The voltage on the output line 130 discharges more slowly than the voltage on the first node 160 due to the larger capacitance of the control line compared with the first and second nodes 160. The voltage on the second node 165 discharges quickly at first compared with voltage on the output line 130 and then discharges more slowly because the voltage clamp 145 conducts after the voltage across the voltage clamp is larger than about 1.3 V. The conducting voltage clamp 145 holds the voltage on second node 165 higher than the voltage would be without the voltage clamp. The voltage across the protection device 140 peaks at 1.65V because of voltage clamp 145. Therefore, the voltage clamped protection device 105 is not damaged by hot carrier injection because the peak voltage across the device is below the threshold for hot carrier injection.

In the embodiment of FIG. 1, the voltage clamp 145 is formed from the two diode-connected n-channel MOS transistors 170. In other embodiments, the voltage clamp 145 is formed from one or more forward biased diodes, one or more diode-connected field effect transistors each of either n-channel or p-channel, one or more diode-connected bipolar transistors each of either NPN or PNP type or one or more zener diodes in reverse bias or any combination of the above.

In the embodiment of FIG. 1, the gate of the protection device 140 and the gate of the intermediate protection device 110 are connected to the same voltage reference line 150. In other embodiments, the gate of protection device 140 and gate of intermediate protection device 110 are connected to different voltage reference lines with different reference voltages. The values of the voltage references are selected to protect the control switch 115, the intermediate protection device 110 and the protection device 140 by controlling the voltages of the first and second nodes 160, 165 to protect the control switch 115, the intermediate protection device 110 and the protection device 140.

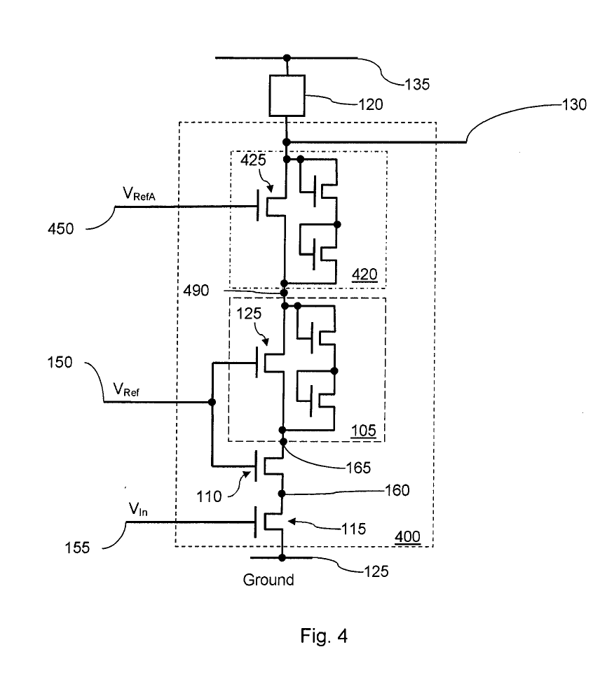

FIG. 4 is a schematic diagram of an output driver 400 according to an embodiment. Output driver 400 is similar to output driver 100 but includes an additional voltage clamped protection device 405 formed in the same manner as the voltage clamped protection device 105. The additional voltage clamped protection device 405 is disposed between the voltage clamped protection device 105 and the output line 130. A reference voltage line 450 is connected to a gate of a protection device 425 in the additional enhanced protection device 405. A voltage V_{RefA} on reference voltage line 450 is selected to control the voltage at a node 490 between the additional voltage clamped protection device 405 and the voltage clamped protection device 105.

In other embodiments, more than one additional voltage clamped protection device 405 are connected in series between the voltage clamped protection device 105 and the output line 130. A corresponding voltage reference for each additional voltage clamped protection device connected to an additional reference voltage line with a voltage selected to control a voltage at a node between the corresponding additional enhanced protection device and the adjacent enhanced protection device closer to the control switch 115.

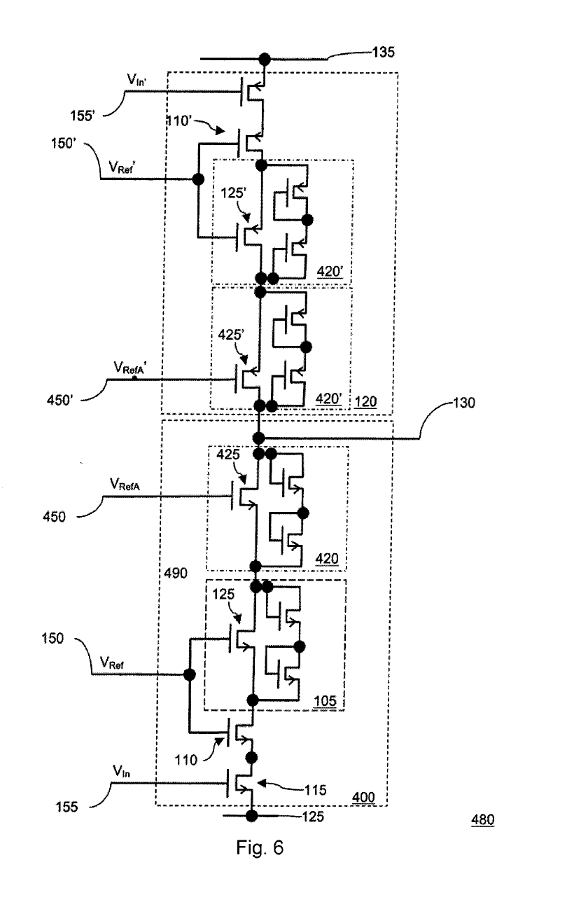

In some embodiments, the load 120 for output driver 400 is a resistor. In other embodiments, the load is another similar complementary output driver to output driver 400, but formed from p-type devices. FIG. 6 is an embodiment of an output driver 480 in which the load 120 is a complementary-symmetric version of output driver 400. Each element in load 120 with a “′” being the complementary element to the element without a “′” in the output driver 100. Each transistor in load 120 being a p-channel (MOS) transistor. The complementary output driver 480 has a complementary input line 455′ and complementary voltage reference line 450′.

The embodiments of FIGS. 1 and 4 are formed with n-channel MOS transistors. In other embodiments, the complementary circuit to the circuits of FIGS. 1 and 4 are formed from p-channel MOS transistors.

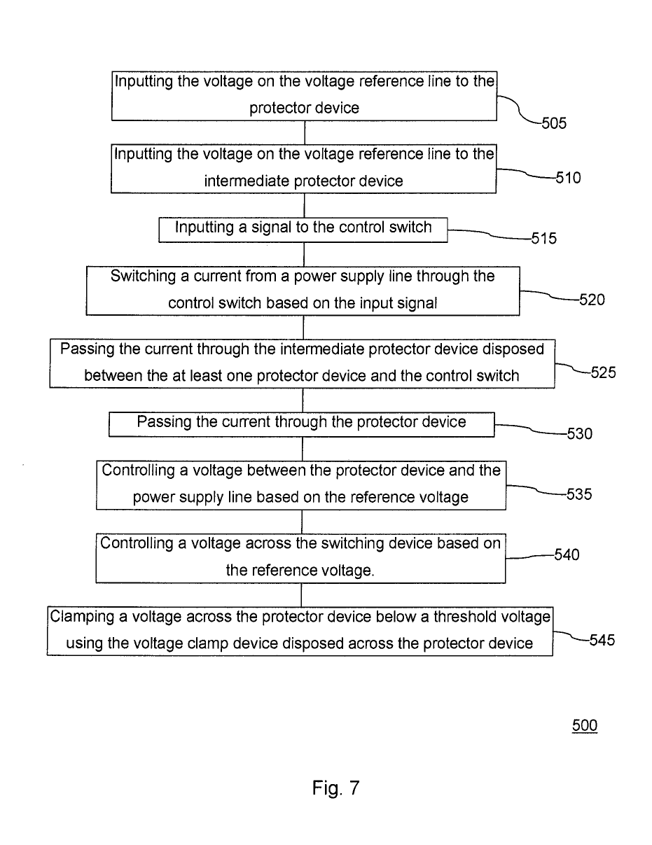

FIG. 7 is a flow chart 500 for a method of operating the output driver of FIG. 1 according to an embodiment.

At step 505, the voltage value on the voltage reference line 150 is input to the gate of the protection device 140. The method proceeds to step 510.

At step 510, the voltage value on the voltage reference line 150 is input to the gate of the intermediate protection device 110. The method proceeds to step 515.

At step 515, a signal is input on the input line 155 to the gate of the control switch 115. The method proceeds to step 520.

At step 520, the control switch 115 switches on and a current from the ground power line 125 to flow through the control switch based on the signal input to the input line 155. The method proceeds to step 525.

At step 525, the current passes through the intermediate protection device 110 disposed between the protection device 140 and the control switch 115. The method proceeds to step 530.

At step 530, the current passes through the protection device 140. The method proceeds to step 535.

At step 535, a voltage between the source of the protection device 140 and the ground power line 125 is controlled by the protection device 140 based on the voltage value on the voltage reference line 150. The method proceeds to step 540.

At step 540, a voltage across the control switch 115 is controlled by the intermediate protection device 110 based on the voltage value on the voltage reference line 150. The method proceeds to step 545.

At step 545, the voltage across the protection device 140 is clamped below a predetermined threshold voltage of the voltage clamp 145 using the voltage clamp 145 disposed across the protection device 140.

The above method is an example, and any order of the above method steps compatible with embodiments of the disclosure is within the scope of this disclosure. Further, methods comprising method steps in addition to the method steps discussed above, inserted before, between or after the above method steps are within the scope of this disclosure.

An output driver comprising, a power supply line, a control switch, at least one protection device, an output line and at least one voltage clamp device. The control switch disposed between the at least one protection device and the power supply line. The at least one protection device disposed in a series arrangement between the output line and the control switch. The at least one voltage clamp device disposed across a corresponding one of the at least one protection device, the at least one voltage clamp device adapted to clamp a voltage across the corresponding protection device below a predetermined threshold voltage.

A method of operating an output driver comprising, inputting a signal to a control switch, switching a current from a power supply line through the control switch based on the input signal, passing the current through at least one protection device, and clamping a voltage across each of the at least one protection device. The voltage across each of the at least one protection device clamped below a corresponding predetermined threshold voltage using a corresponding voltage clamp device disposed across each of the at least one protection device.

An output driver comprising a power supply line, a control switch, an intermediate protection device, a protection device, an output line, a voltage clamp device and a reference voltage line. The control switch disposed between the intermediate protection device and the power supply line. The intermediate protection device disposed between the protection device and the control switch. The protection device disposed between the output line and the control switch. The voltage clamp device disposed across the protection device, the voltage clamp device adapted to clamp a voltage across the protection device below a predetermined threshold voltage. The reference voltage line connected to a gate of the protection device and a gate of the intermediate protection device.

It will be readily seen by one of ordinary skill in the art that the disclosed embodiments fulfill one or more of the advantages set forth above. After reading the foregoing specification, one of ordinary skill will be able to affect various changes, substitutions of equivalents and various other embodiments as broadly disclosed herein. It is therefore intended that the protection granted hereon be limited only by the definition contained in the appended claims and equivalents thereof.

What is claimed is:

1. An output driver having an input node and an output node, the output driver comprising:
a control switch coupled between a power line and the output node, and being configured to selectively enable a current path between the output node and the power line in response to a signal on the input node;
at least one protection device coupled between the output node and the control switch in a series arrangement; and
at least one voltage clamp device coupled to the at least one protection device in a parallel arrangement and configured to clamp a voltage across the at least one protection device at a voltage level value below a predetermined threshold voltage.

2. The output driver of claim 1, further comprising at least one first voltage reference line corresponding to each of the at least one protection devices, and each of at least one protection device adapted control a voltage between the at least one protection device and the power line based on a corresponding first reference voltage on the at least one first voltage reference line.

3. The output driver of claim 2, further comprising an intermediate protection device disposed between the at least one protection device and the control switch.

4. The output driver of claim 3, further comprising a second voltage reference line adapted to output a second reference voltage, and the intermediate protection device adapted to control a voltage across the control switch based on the second reference voltage.

5. The output driver of claim 3, the intermediate protection device adapted to control a voltage across the control switch based on the corresponding first reference voltage on an one of the at least one first voltage reference line.

6. The output driver of claim 1, the at least one voltage clamp device formed by at least one of a diode, a diode-connected field effect transistor, a diode-connected bipolar transistor or zener diode.

7. The output driver of claim 1, the at least one voltage clamp device formed by two diode-connected field effect transistor in a series arrangement.

8. The output driver of claim 3, each of the control switch, the at least one protection device and the intermediate protection device formed from a field effect transistor.

9. The output driver of claim 1, the at least one voltage clamp device adapted to clamp the voltage across the at least one protection device below a predetermined threshold voltage device during at least one of a transition of the output node from a low voltage state to a high voltage state.

10. An output driver comprising:
an intermediate protection device;
a control switch, the control switch disposed between the intermediate protection device and a power supply line;
an output line;
a protection device, the protection device disposed between the output line and the control switch;
the intermediate protection device disposed between the protection device and the control switch;
a voltage clamp device disposed across the protection device and adapted to clamp a voltage level value across the protection device below a predetermined threshold voltage; and
a reference voltage line connected to a gate of the protection device and a gate of the intermediate protection device.

11. The output driver of claim 10, the voltage clamp device formed by at least one of a diode, a diode-connected field effect transistor, a diode-connected bipolar transistor or zener diode.

12. The output driver of claim 10, the voltage clamp device formed by two diode-connected field effect transistor in a series arrangement.

13. A method of operating an output driver comprising:
inputting a signal to a control switch;
switching a current from a power supply line through the control switch based on the input signal;
passing the current through at least one protection device; and
clamping a voltage across each of the at least one protection device below a corresponding predetermined threshold voltage using a corresponding voltage clamp device disposed across each of the at least one protection device.

14. The method of claim 13, further comprising
inputting at least one first reference voltage to each of the at least one protection device; and
controlling a voltage between the at least one protection device and the power supply line based on the at least one first reference voltage.

15. The method of claim 13, further comprising passing the current through an intermediate protection device disposed between the at least one protection device and the control switch.

16. The method of claim 15, further comprising
inputting second reference voltage to the intermediate protection device; and
controlling a voltage across the switching device based on the second reference voltage.

17. The method of claim 13, further comprising forming the corresponding voltage clamp device using at least one of a diode, a diode-connected field effect transistor, a diode-connected bipolar transistor or zener diode.

18. The method of claim 13, further comprising forming the corresponding voltage clamp device using two diode-connected field effect transistor in a series arrangement.

19. The method of claim 15, forming each of the control switch, the at least one protection device and the intermediate protection device from a field effect transistor.

20. The method of claim 13, clamping the voltage across the at least one protection device below a corresponding predetermined threshold voltage with the corresponding voltage clamp device during at least one of a transition of the input signal from a low voltage state to a high voltage state or vise versa.
